(19) United States
(12) Patent Application Publication
(10) Pub. No.: US 2014/0052477 A1
(43) Pub. Date: Feb. 20, 2014

(54) OWNER-DIRECTED UNIVERSAL LIFE INSURANCE PRODUCT

(71) Applicant: RICHARD KENNETH SKAUGE, Calgary (CA)

(72) Inventor: RICHARD KENNETH SKAUGE, Calgary (CA)

(73) Assignee: OLYMPIA TRUST COMPANY, Calgary (CA)

(21) Appl. No.: 13/585,603

(22) Filed: Aug. 14, 2012

(51) Int. Cl. G06Q 40/08

(52) U.S. Cl. 705/4

(57) ABSTRACT

A universal life type insurance policy is provided with added automated features controlled by policy documents and account authorization arrangements with service providers, which enables the policy holder to have the benefits of a tax-advantaged life insurance arrangement and retain control over the types of investment in asset accounts associated with the life insurance arrangement. Simultaneously, the arrangement may provide for fall-back authorizations such that the arrangement maintains the tax-advantaged status and, so long as asset balances permit, currency of payment of policy premiums.

### FIELD OF THE INVENTION

The invention relates to a life-insurance product which comprises a universal life insurance policy where an owner of the insurance product is permitted to manage the assets in the account, and the account may have safeguards against policy lapse for non-payment of premium and/or loss of tax-advantaged status of the account, by pre-configured authorization settings and the inclusion of at least one other asset side account and optionally may include at least one trust account.

### BACKGROUND

Universal Life Insurance Policies are well-known products which typically include two elements: a life insurance policy which pays a death benefit, and an investment component which consists of contributions of cash from the policy holder to the insurer and which is invested by the insurer. The policyowner is usually given the option of choosing one or more managed mutual fund types which may include cash, debt, or equity.

In typical policies, the contract provides an obligation for the insurer to the policyholder which is calculated based upon what the earnings on the contributed funds would have been if they had been invested in funds like those chosen. The insurer's obligation may be to reimburse the calculated balance (less certain fees and penalties) at the termination of the policy, or to use that amount together with term insurance bought for the policyholder, to pay a death benefit associated with the policy. In some cases, the earnings obligations based on the contributions, which remain in the policy, are tax-advantaged by being sheltered from taxation while earned and accumulated, and may also be tax-advantaged when eventually paid out as part of a death benefit to the policy beneficiaries.

There are several disadvantages to these types of Universal Life policies, most of which can be referred to as a lack of control and input by the policy holder over the investments made by the insurer of the policy holder's contributed cash. Additionally, there may be problems with inadvertent policy lapse in the event of unforeseen shortfalls in payments to premiums, or the loss of tax-advantaged status by virtue of too-successful investment strategies (which seems counter-intuitive and can motivate low-return or fixed-return investments to match tax rules and actuarial account balance and reserve estimates).

Within the realm of Universal Life and similar policy products, several innovative structure have been disclosed in applications for patent protection, some of which have been granted. By way of introduction to the subject-matter, this part describes what the inventor considers to be relevant documents in the US and Canadian patent systems:

U.S. Patent Publication No. 20030110061 discloses a tax-advantaged investment product, more particularly, a simplified flexible premium life insurance product, in which the traditional cost of insurance charge is not charged separately. An asset charge, which is calculated as a percentage of the accrued value of the insurance policy, is deducted from any premiums paid and/or from cash dividends accrued in the policy. There is no requirement for the involvement of any tax-advantaged status for the policy, and no ability of any entity but the insurer to direct the investment of any contributions by the policy-holder. The focus of this invention is the tying of the policy's costs to a percentage charge against the policy's net assets, rather than the conventional mechanism of directly charging premium and administration and risk-related charges to the policy holder.

U.S. Patent Publication No. 20070168235 discloses a variable annuity or other investment vehicle that invests in a single public mutual fund to allow an investor to be taxed on a non-deferred capital gains basis as opposed to a tax-deferred income basis. An insurance policy may be wrapped around, or otherwise associated with, the variable annuity or other investment vehicle. The investment choice of the policy holder is a one-time choice of a single mutual fund at the beginning of the policy, without any ability to direct further investment or re-investments. The invention deals primarily with annuities and not life-insurance, with the goal being to make the investment gains taxable as capital gains and not as income. There is no mechanism to protect any tax-advantaged status of any investment, and the types of investments capable of being made are very restricted (mutual funds and hedge funds), and are always pooled funds and managed funds.

U.S. Pat. No. 7,644,022 discloses a program that administers a method of funding life insurance policies using annuities that are purchased at least in part using borrowed money, using business and trust structures to reduce and/or eliminate tax. The investing can be done either directly by the policy or through a trust and/or other business entity. As an internal investment of the insurance policy the income generated by the annuity and the inside build-up are non-income taxable to the owner of the policy. The resulting death benefits are also non-income taxable to the beneficiary. There is no investment beyond an annuity style investment, and the invention requires that a charity or similar participant be a partner in the ownership of the annuity. The annuity must be a life-only immediate annuity sufficient for funding of all benefits including any premium payments, annuity payments, and the invention is not directed to life-insurance as its main goal—any life insurance benefit is used to pay off the remaining balance of the loan initially taken out by the policy-holder to acquire the annuity. There is no mechanism to protect any tax-advantaged status of any internal account. There is no mechanism for the policy-holder to direct the investments in the arrangements.

U.S. Patent Publication No. 20040243451 discloses systems and methods that provide a shareholder-owned life insurance product which enables a shareholder in a small or closely held company to purchase a large-scale life insurance product, independent of the limited operating budget of his company, in which he can invest a large sum of private wealth. The shareholder can control risk exposure, obtain the tax benefits typically associated with an individual beneficiary life insurance policy, and achieve the cost savings of a large-scale corporation owned life insurance transaction, while avoiding the underwriting restrictions and costs associated with individual insureds and policies with large face amounts. This invention requires a shareholder group to qualify as a type of policy which can invest in lower-quality and higher-risk assets (such as the shares of the shareholders' corporation), but is otherwise not a tax-advantaged asset or policy type. There is no single individual policy holder (by definition this requires a group of insured lives), and no single individual may direct the investment of any associated asset accounts; rather, shareholders are insuring other lives. There is no mechanism to protect or maintain any investment's tax-advantaged status (as there is no tax-advantaged account).

Canadian Patent Application No. 2,638,473 discloses a system for providing an insurance product for at least one insured customer, including a communication device for receiving at least one application, each application associated with an applicant and including information about the applicant, a processor configured to determine for each application if the applicant qualifies as an insured customer, and a memory configured for storing an account record associated with each insured customer having at least one insured event associated with that insured customer, a benefit amount payable in association with the at least one insured event, an insurance cost, and a cash value based on predetermined account record factors, wherein the processor may define a reserve fund, determine an investment performance associated with the reserve fund during at least one period of time, and calculate a performance credit amount based on the investment performance of the reserve fund and the cash value. The invention administers insurance policy accounts for the benefit of customers; it calculates minimum reserves for expected policy claims to assist in regulatory compliance, but it does not deal with self-directed investment accounts. It is, instead, directed at the automation of management of an insurance company and not at managing a policy for an individual policy-holder. There is no attention paid to tax-advantaged asset accounts. The “user” of the system is the insurance provider (12) and not the policy-holder.

Applicant refers the reader to http://www.rbcinsurance.com/samplepolicy/index.html which is a copy of a Specimen or example Universal Life policy of the prior art offered by RBC Insurance (TM RBC Insurance Holdings Inc. and its affiliates).

Applicant refers the reader to http://www.qtrade.ca/investor/en/helpcenter/forms.jsp which is a copy of an example Q-Trade account, which shows how a self-directed securities trading account arrangement operates. Q-Trade is a TM of QTrade Securities Inc.

### SUMMARY OF INVENTION

The applicant discloses a policyholder-directed insurance product comprising:

### a. a Life Insurance Policy

### b. an Investment Asset Account

### c. a Deposit Side Account

where a Policy Holder engages contractually with an Insurer to purchase and pay premiums on the Insurance Policy, the contract documents spell out instructions and rights and obligations between the policy-holder and the insurer with respect to the nature and benefits of the Investment Asset Account (which may be a tax-advantaged investment asset account), the parties may include a Trader to manage trades of securities and other permitted assets associated with the Investment Asset Account at the direction of the PolicyHolder, and a relationship with limits of authority and behaviors may be set up with a custodian or trustee to hold the Deposit Side Account for the PolicyHolder into which the Policy Holder, the Insurer or the Trader can deposit funds, and from which can be drawn funds to pay commissions, management fees and costs associated with the Insurance product. In an embodiment, the Policy Holder is the owner of the Deposit Side Account and the Insurance Policy or its benefits, obligations or the value associated with the Investment Asset Account; and the Policy Holder may deposit funds into the Deposit Side Account and funds or permitted assets into the Tax-Advantaged Asset Account.

In an embodiment, the Policy Holder has authorized the Insurer to liquidate assets in the Tax-Advantaged Asset Account and to pay resulting cash from the Tax-Advantaged Asset Account in at least the following circumstances:
i. if the asset balance or value of the assets associated with the Tax-Advantaged Asset Account approaches or exceeds a threshold set by taxing authorities with competent jurisdiction which would cause the Tax-Advantaged Asset Account to lose its Tax-Advantaged status—a liquidation and withdrawal would be done to reduce the value or asset balance inside the Tax-Advantaged Asset Account to below that threshold; or
ii. if the Insurance Policy premiums were not paid by the Policy Holder or from the Deposit Side Account in order to keep the Insurance Policy in force—a liquidation and withdrawal would be done to pay those premiums to keep the Insurance Policy in force.

In a preferred embodiment, the insurance product described above is provided with a custodian or trustee which holds one or more of: the Tax-Advantaged Asset Account; the Broker Account; or the Deposit Side Account.

The invention disclosed here provides for a universal life insurance type policy with added automated features controlled by policy and associated contract documents and account authorization arrangements with service providers, which enables the policy holder to have the benefits of a tax-advantaged life insurance arrangement similar in operation to a prior art Universal life policy, but also to retain control over the types of investment in asset accounts associated with the life insurance arrangement. Simultaneously, the arrangements can provide for fall-back authorizations such that the arrangement maintains the tax-advantaged status and, so long as asset balances permit, currency of payment of policy premiums.

### BRIEF DESCRIPTION OF THE DRAWINGS

Drawings are included for the purpose of illustrating certain aspects of the invention. Such drawings and the description thereof are intended to facilitate understanding and should not be considered limiting of the invention. Drawings are included, in which:

FIG. 1 is a block-diagram of an embodiment of the invention showing entity relationships;

### DETAILED DESCRIPTION OF VARIOUS EMBODIMENTS

The detailed description set forth below in connection with the appended drawing is intended as a description of various embodiments of the present invention and is not intended to represent the only embodiments contemplated by the inventor. The detailed description includes specific details for the purpose of providing a comprehensive understanding of the present invention. However, it will be apparent to those skilled in the art that the present invention may be practiced without these specific details.

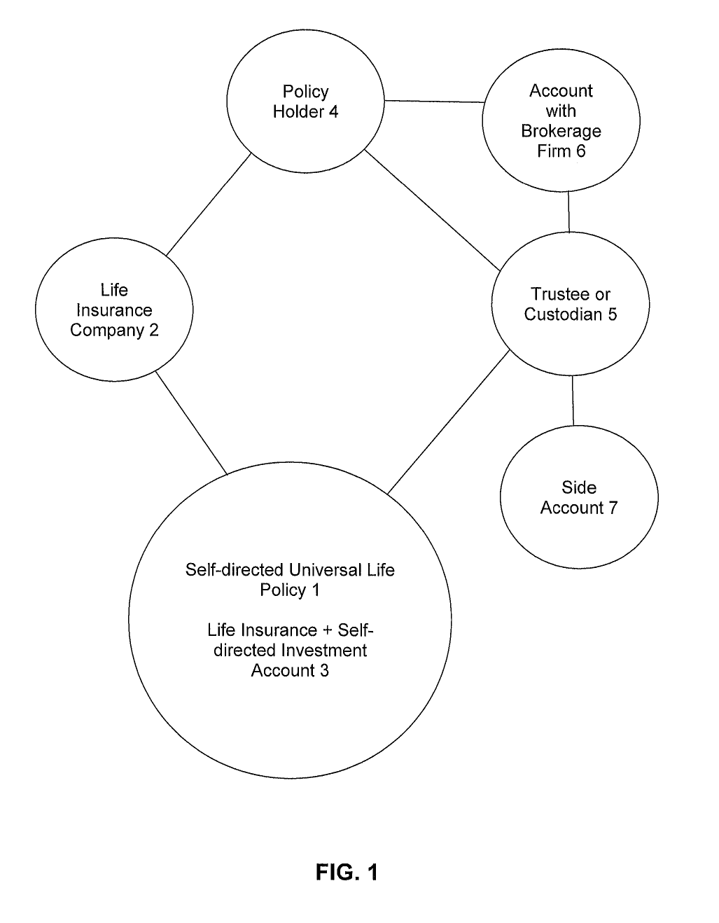

Referring to FIG. 1, an embodiment of an insurance product of the invention comprises a life insurance policy 1 sold to a policy holder by an insurance company 2 that is tied to a self-directed investment account which may be a trust account 3. The assets held in the investment account 3 are used to pay for the costs associated with maintaining the insurance policy. The costs may include premiums, commissions, fees, or the like. The deposit Side Account 7 may be the first source of payment of those types of costs in a preferred embodiment.

The policy holder 4 may manage the assets held in the investment account 3. The policy holder may contribute to the investment account 3 cash, investments, or other assets that can be converted to cash. The investment account 3 may be limited to the type of assets which it may include, in order to qualify and remain qualified as a tax-advantaged investment account where gains and losses are not recognized as taxable events when they occur, but are deferred into the future or may not be taxable at all. A trustee or Custodian 5 may be authorized to liquidate a portion or all of the contents of the investment trust account 3 in order to pay for the costs associated with the insurance policy. Examples of the types of investment that the policy holder may make may include:
a) Securities listed on a recognized stock exchange;
b) Debt securities whether listed or not;
c) Mortgages or interests in mortgages; and
d) Private company shares to the extent that the policy holder owns less than 10% of any class of shares.

In a further embodiment, the policy holder 4 opens one or more brokerage accounts 6 associated with the investment account 3 and the policy holder 4 instructs the corresponding brokerage firm or representative 6 to purchase or sell certain securities associated with the investment account 3. Settlement of the purchases and sales will be made for the account of the custodian or trustee and associated with the policy 1, although transactions (within limits and authorizations) would be directed by the policy holder 4 or his agent and transacted by the broker 6. Any purchases or sales not requiring a registered representative may be made directly with the custodian or trustee 5 on direction of the policy holder 4 (for example contributing a mortgage or interest in a mortgage) into or from the investment account 3. It is to be noted that transactions can in some embodiments have a step involving an intermediate deposit into a withdrawal/transfer from the Deposit Side Account 7.

In another embodiment, investments associated with a life insurance policy 1 are tax-advantaged (i.e. are exempt from tax or taxed at a lower rate) to the extent that the value of the assets 3 within the policy 1 is below certain actuarial limits, which may be based on the state of the insurance policy and certain actuarial evidence related to the eventual death or other benefit of the insurance policy. In this embodiment, the policy holder 4 has directed the custodian or trustee 5 or the Insurance Company 2 to maintain the tax-advantaged status of the policy 1. For example, when the assets 3 within the policy 1 exceed the actuarial limits, the custodian or trustee 5 notifies the policy holder 4 that a certain amount of assets have been transferred to a separate (side) account 7 created in association with the insurance policy 1. The purpose of the separate side account 7 is to receive and hold excess funds that would otherwise jeopardize the account's 3 tax-advantaged status if kept within the policy 1. The policy holder 4 may be given a time limit, for example, 30 days, to respond to the notification and to instruct which assets to transfer to the separate side account 7. If the policy holder 4 does not respond within the time limit, the custodian or trustee 5 may be permitted by contract to unilaterally effect certain rules to determine which assets 3 to transfer in order to maintain the tax-advantaged status of the policy 1.

The insurance policy 1 and associated accounts comprise a deposit side account 7, a tax-advantaged asset account and insurance 3. The insurance is provided for the policy holder 4 by the insurer 2 and the policy holder 4 pays premiums (and may be required to pay other fees) to maintain the policy 1. The purchased policy would be a universal life style of policy. The purpose of the deposit side account 7 is to accept funds, or assets from the policy holder 4 or for the benefit of the policy holder 4 from other entities 5, 6, 7. The tax-advantaged asset account 3 holds funds contributed or earned by or for the policy holder 4 together with insurance 3. There may be limits on the amounts which the policy holder 4 can deposit into the tax-advantaged asset account 3, as described above.

A custodian or a trustee 5 would hold or be responsible for the obligations to the policyholder 4 associated with the deposit account 7 and the tax-advantaged asset account 3. The policy holder 4 is permitted, typically within defined authorization limits under the contract to instruct a brokerage firm 6 or broker to trade assets associated with the tax-advantaged asset account 3, which allows the policy holder 4 to control the investment of funds in the tax-advantaged asset account 3.

The policy holder 4 has authorized the custodian or trustee 5 to withdraw funds from the deposit side account 7, or the tax-advantaged asset account 3 to pay any costs associated with the policy 1. The costs include administration fees, commissions, trading costs, and insurance premiums. The policy holder has also authorized the custodian or trustee 5 to move funds from the tax-advantaged asset account 3 to the deposit side account 7 if the value of the assets in the former account exceeds permitted limits, in order to preserve the tax-advantaged nature of the former account.

The upper limit to the value in the Investment Account 3 may (by example) be an amount determined by actuarial means required at the relevant point in time to fund and pay all premiums required to keep a policy on an insured life current to 100 years. The life insured need not be the policy holder's.

The Investment Account 3 value may be a calculated value with reference to amounts which could have been earned if the contributions, withdrawals, investment transactions, earning and losses, made or directed by the Policyholder 4 had been made into a segregated trust or similar account, notwithstanding that the value may in fact or in law have been purely contractual obligations assumed by the insurer 2 either in whole or in part (and thus putative or “phantom” in nature).

The side account 7, investment account 3, and any associated broker, custodial or other accounts may, either individually or in any combination, be contract obligations, segregated or blended funds, co-mingled or isolated and operated as custodial or trust or agency or other obligations or within separate trust, custodial or agent entities or structures, and the spirit or intention of this invention will not have been compromised or avoided. In a preferred embodiment, a Custodian such as a bank, broker or trust company, maintains the Deposit Side Account 7. In a preferred embodiment, a Trustee holds as a segregated fund the Investment Asset Account 3, for the policy-determined benefit of the Insurance Company and the Policy holder (and beneficiary) of the Insurance Policy.

The broker 6 account or relationship will typically be a deposit against payment (DAP) style of account, with each transaction being directed by the policyholder 4 but settled against the assets associated with the Investment Account 3 for the Insurer 2 associated with the policy 1 for the benefit of the policy holder 4.

The previous description of the disclosed embodiments is provided to enable any person skilled in the art to make or use the present invention. Various modifications to those embodiments will be readily apparent to those skilled in the art, and the generic principles defined herein may be applied to other embodiments without departing from the spirit or scope of the invention. Thus, the present invention is not intended to be limited to the embodiments shown herein, but is to be accorded the full scope consistent with the claims, wherein reference to an element in the singular, such as by use of the article “a” or “an” is not intended to mean “one and only one” unless specifically so stated, but rather “one or more”. All structural and functional equivalents to the elements of the various embodiments described throughout the disclosure that are known or later come to be known to those of ordinary skill in the art are intended to be encompassed by the elements of the claims. Moreover, nothing disclosed herein is intended to be dedicated to the public regardless of whether such disclosure is explicitly recited in the claims.

1. (canceled)

2. (canceled)

3. (canceled)

4. (canceled)

5. An automated process for administering an insurance product comprising a life insurance policy, a tax-advantaged asset account, and a deposit side account, the insurance product being for the benefit of a policy holder, the policy holder being the owner of the deposit side account, the life insurance policy or its benefits, and obligations or benefits associated with the tax-advantaged asset account, the process comprising:
the policy holder and an insurer engaging contractually for the policy holder to purchase and pay premiums on the life insurance policy;
engaging contractually with the insurer with respect to the nature and benefits of the tax-advantaged asset account;
engaging contractually with a trader to manage trades of securities and other permitted assets associated with the tax-advantaged asset account with the authority of the policy holder which authority may be delegated;
engaging contractually with a custodian or trustee to hold the deposit side account for the policy holder into which the policy holder, the insurer, or the trader can deposit funds, and from which the policy holder, the insurer, or the trader can draw funds to pay commissions, management fees, and costs associated with the insurance product;
one or both of: (i) the policy holder depositing funds into the deposit side account; and (ii) the policy holder depositing funds or permitted assets into the tax-advantaged asset account; and
the policy holder authorizing the insurer to liquidate assets in the tax-advantaged asset account and to transfer the resulting value from the liquidation in at least the following circumstances:
(i) if the asset balance or value of the assets associated with the tax-advantaged asset account approaches or exceeds a threshold set by taxing authorities with competent jurisdiction which would cause the tax-advantaged asset account to lose its tax-advantaged status, to liquidate assets and transfer value sufficient to reduce the asset balance to below the threshold; or
(ii) if the insurance policy premiums were not paid by the policy holder or from the deposit side account for keeping the insurance policy in force, to liquidate assets and transfer value sufficient that the shortfall in premium payment can be made up and paid.

6. The automated process of claim 5 wherein the liquidation reduces the value or asset balance inside the tax-advantaged asset account to below the threshold.

7. The automated process of claim 5 wherein the resulting cash from the liquidation pays the insurance policy premiums to keep the insurance policy in force.

8. The automated process of claim 5 wherein the custodian or trustee holds one or more of:
a. the tax-advantaged asset account;
b. a broker account; and
c. the deposit side account.

9. An automated process for operating an insurance product comprising a life insurance policy, an investment asset account, and a deposit side account, the insurance product being operated for the benefit of a policy holder, the policy holder being the owner of the deposit side account, the life insurance policy or its benefits, obligations or benefits associated with the investment asset account, the process comprising:
the policy holder and an insurer engaging contractually for the policy holder to purchase and pay premiums on the life insurance policy;
engaging contractually with the insurer with respect to the nature and benefits of the investment asset account;
engaging contractually with a trader to manage trades of securities and other permitted assets associated with the investment asset account at the direction of the policy holder;
engaging contractually with a custodian or trustee to hold the deposit side account for the policy holder into which the policy holder, the insurer, or the trader can deposit funds, and from which the policy holder, the insurer, or the trader can be draw funds to pay commissions, management fees, and costs associated with the insurance product;
one or both of: (i) the policy holder depositing funds into the deposit side account; and (ii) the policy holder depositing funds or permitted assets into the investment asset account; and
the policy holder authorizing the insurer to liquidate assets in the investment asset account and to pay out the resulting cash from the liquidation if the insurance policy premiums were not paid by the policy holder or from the deposit side account for keeping the insurance policy in force.
